(19) United States
(12) Patent Application Publication
(10) Pub. No.: US 2023/0378712 A1
(43) Pub. Date: Nov. 23, 2023

(54) GAS LASER AND WASTE HEAT RECOVERY SYSTEM

(71) Applicant: Sumitomo Electric Industries, Ltd., Osaka (JP)

(72) Inventor: Takafumi OHTSUKA, Osaka-shi (JP)

(73) Assignee: Sumitomo Electric Industries, Ltd., Osaka (JP)

(21) Appl. No.: 18/130,472

(22) Filed: Apr. 4, 2023

(30) Foreign Application Priority Data
May 18, 2022 (JP) 2022-081696

(51) Int. Cl. H01S 3/095; H01S 3/041; H01S 3/034

(52) U.S. Cl. CPC H01S 3/095; H01S 3/041; H01S 3/034

(57) ABSTRACT

A gas laser according to an embodiment includes a gas serving as a laser medium, a thermal radiation source having wavelength selectivity and configured to emit excitation light for excitation of the gas by thermal radiation, and an optical resonator for causing emission light emitted from the gas in response to the excitation light to resonate.

### CROSS REFERENCE TO RELATED APPLICATIONS

This application claims priority based on Japanese Patent Application No. 2022-081696 filed on May 18, 2022, and the entire contents of the Japanese patent application are incorporated herein by reference.

### TECHNICAL FIELD

The present disclosure relates to a gas laser and waste heat recovery system.

### BACKGROUND

Non-PTL 1 discloses a carbon dioxide gas laser excited by electric discharge. Non-PTL 2 discloses a carbon dioxide gas laser excited by a hydrogen bromide laser.

Non-PTL 3 discloses a thermal radiation source using a plasmonic meta-material. The thermal radiation source has wavelength selectivity. Non-PTL 4 discloses a thermal radiation source that emits thermal radiation by electrical heating.
[Non-PTL 1] A. Yariv, “QuantumElectronics 3rd Edition”, Wiley (1989) p. 216 to 224
[Non-PTL 2] T. Y. Chang and O. R. Wood, “Opticallypumped atmospheric-pressure CO2 laser”, Applied Physics Letters21 (1972) 19
[Non-PTL 3] X. Liu, et al, “Taming the Blackbody with Infrared Metamaterials as Selective Thermal Emitters”, Physical Review Letters 107 (2011) 045901
[Non-PTL 4] Ueba and Takahara, “Spectral Control of Thermal Radiation by Metafilament”, 74th JSAP (Japan Society of Applied Physics) Autumn Meeting, (2013), 18a-C14-7

### SUMMARY

A gas laser according to an embodiment includes a gas serving as a laser medium, a thermal radiation source having wavelength selectivity and configured to emit excitation light for excitation of the gas by thermal radiation, and an optical resonator for causing emission light emitted from the gas in response to the excitation light to resonate.

### BRIEF DESCRIPTION OF THE DRAWINGS

FIG. 1 schematically illustrates a gas laser according to one embodiment.

FIG. 2 is a graph illustrating an example of a thermal radiation spectrum of a thermal radiation source.

FIG. 3 is a cross-sectional view schematically illustrating a gas laser according to another embodiment.

FIG. 4 is a cross-sectional view taken along line IV-IV of FIG. 3.

FIG. 5 is a plan view illustrating an example of a thermal radiation source.

FIG. 6 is a plan view of a portion of FIG. 5.

FIG. 7 is a cross-sectional view taken along line VII-VII of FIG. 6.

FIG. 8 is a cross-sectional view schematically illustrating a gas laser according to another embodiment.

FIG. 9 is a cross-sectional view taken along line IX-IX of FIG. 8.

FIG. 10 is a cross-sectional view schematically illustrating a gas laser according to another embodiment.

FIG. 11 is a cross-sectional view taken along line XI-XI of FIG. 10.

FIG. 12 is a cross-sectional view schematically illustrating a gas laser according to another embodiment.

FIG. 13 is a cross-sectional view taken along line XIII-XIII of FIG. 12.

FIG. 14 is a cross-sectional view schematically illustrating a gas laser according to another embodiment.

FIG. 15 is a cross-sectional view taken along line XV-XV of FIG. 14.

FIG. 16 is a plan view illustrating an example of a thermal radiation source.

FIG. 17 is a cross-sectional view schematically illustrating a gas laser according to another embodiment.

FIG. 18 is a cross-sectional view along line XVIII-XVIII of FIG. 17.

FIG. 19 schematically illustrates a waste heat recovery system according to one embodiment.

FIG. 20 schematically illustrates a waste heat recovery system according to another embodiment.

FIG. 21 schematically illustrates a waste heat recovery system according to another embodiment.

### DETAILED DESCRIPTION

The present inventor searched for a new light source that emits excitation light for exciting gas.

The present disclosure provides a gas laser and waste heat recovery system comprising a new light source emitting excitation light.

### DESCRIPTION OF EMBODIMENTS OF PRESENT DISCLOSURE

First, embodiments of the present disclosure will be listed and explained.

(1) A gas laser includes a gas serving as a laser medium, a thermal radiation source having wavelength selectivity and configured to emit excitation light for excitation of the gas by thermal radiation, and an optical resonator for causing emission light emitted from the gas in response to the excitation light to resonate.

According to the gas laser, the thermal radiation source emits excitation light by thermal radiation. As the emission light emitted from the gas by the excitation light resonates, the laser beam is emitted. The gas laser includes a new light source for emitting excitation light.

(2) In the above (1), a thermally insulated region may be disposed between the gas and the thermal radiation source. In this case, even if the temperature of the thermal radiation source is high, an increase in the temperature of the gas can be suppressed. Therefore, a decrease in the oscillation efficiency of the laser beam can be suppressed.
(3) In the above (1) or (2), the gas laser may further include a container containing the gas. The container may have a cylindrical shape extending along an axis, and the thermal radiation source extends along the axis. In this case, the thermal radiation source can irradiate the excitation light toward the gas in a long region along the axis.
(4) In any one of the above (1) to (3), the gas laser may further include a container containing the gas. The container may has an inner surface including a reflecting surface configured to reflect the excitation light. In this case, the excitation light reaching the reflecting surface without being absorbed by the gas can be reflected toward the gas.
(5) In the above (4), the reflecting surface may be disposed so as to face the thermal radiation source. In this case, even if the excitation light reflected by the reflecting surface is not absorbed by the gas, the reflected excitation light returns to the thermal radiation source. Therefore, the energy for heating the thermal radiation source can be reduced.
(6) In any one of the above (1) to (5), the thermal radiation source may include a resistance heating element, and the gas laser may further include a power source connected to the resistance heating element. In this case, the thermal radiation source can be heated by energization.
(7) In any one of the above (1) to (6), the thermal radiation source may include a conductor, and the gas laser may further include a coil for inductively heating the conductor, and an AC power source for supplying AC power to the coil. In this case, the thermal radiation source can be heated in a non-contact manner.
(8) In any one of the above (1) to (7), the gas laser may further include an electromagnetic wave generator for irradiating the thermal radiation source with electromagnetic waves to heat the thermal radiation source. In this case, the thermal radiation source can be heated in a non-contact manner.
(9) In any one of the above (1) to (8), the gas laser may further include a container containing the gas. The container may include a metal member. In this case, the gas can be cooled by the metal member.
(10) In any one of the above (1) to (9), the gas laser may further include a cooler for cooling the gas. In this case, the gas can be cooled in the cooler.
(11) In any one of the above (1) to (10), the gas laser may further include a container containing the gas. The thermal radiation source may be disposed outside the container, and the container may include a material transmitting the excitation light. In this case, the degree of freedom of arrangement of the thermal radiation source is improved.
(12) A waste heat recovery system includes the gas laser according to any one of the above (1) to (11), and a heating element for heating the thermal radiation source of the gas laser. In this case, the thermal radiation source is heated by the heating element and then excitation light is emitted from the thermal radiation source. As a result, a laser beam is emitted from the gas laser.
(13) In the above (12), the waste heat recovery system may further include a photoelectric cell configured to convert a laser beam from the gas laser into electricity. In this case, the waste heat can be recovered and utilized as electricity.
(14) In the above (12) or (13), the waste heat recovery system may further include a chemical reactor configured to be irradiated with a laser beam from the gas laser. In this case, the waste heat can be recovered and utilized as heat for the chemical reaction.

### Details of Embodiments of Present Disclosure

Hereinafter, embodiments of the present disclosure will be described in detail with reference to the accompanying drawings. In the description of the drawings, the same reference numerals are used for the same or equivalent elements, and redundant description is omitted.

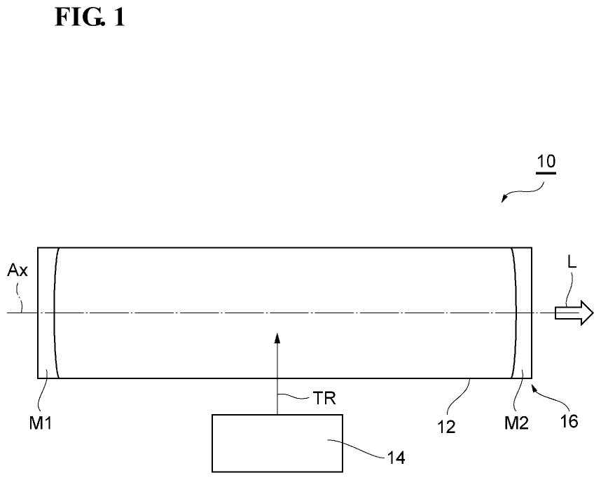

FIG. 1 schematically illustrates a gas laser according to one embodiment. A gas laser 10 shown in FIG. 1 includes gas serving as a laser medium, a thermal radiation source 14 having wavelength selectivity, and an optical resonator 16. The gas as the laser medium may be contained in a container 12. Thermal radiation source 14 emits an excitation light TR for excitation of the gas by thermal radiation. Optical resonator 16 can resonate the emission light emitted from the gas in response to the excitation light TR. Accordingly, a laser beam L is emitted from gas laser 10.

Container 12 may have a cylindrical shape extending along an axis Ax. In one example, container 12 is a cylinder having an outside diameter of 26 mm, an inside diameter of 24 mm, and a length of 120 mm.

Thermal radiation source 14 may be disposed outside container 12 or may be disposed inside container 12. If thermal radiation source 14 is disposed outside container 12, container 12 may include a material transmitting excitation light TR. Container 12 may include at least one of aluminum oxide, zinc oxide, zinc sulfide, zinc selenide, silicon, calcium fluoride, magnesium fluoride, sodium chloride, polyethylene, polypropylene, and polystyrene. Examples of aluminum oxide include sapphire. The reflectivity of the outer surface of container 12 with respect to excitation light TR may be 1% or less. The inner surface of container 12 may include a reflecting surface configured to reflect excitation light TR. The inner surface of container 12 may have a reflectivity of 90% or more with respect to excitation light TR. The reflecting surface may be disposed so as to face a thermal radiation source 114.

Optical resonator 16 is, for example, a Fabry-Perot optical resonator. Optical resonator 16 may include a first mirror M1 and a second mirror M2. First mirror M1 and second mirror M2 are disposed so as to face each other in axis Ax. The reflectivity of first mirror M1 for the emission light is greater than the reflectivity of second mirror M2 for the emission light. Accordingly, laser beam L is emitted from second mirror M2. In one example, the reflectivity of first mirror M1 is 95% and the reflectivity of second mirror M2 is 90%. First mirror M1 may close the first opening of cylindrical shape container 12. The first opening is located at a first end of container 12 in axis Ax. Second mirror M2 may close the second opening of cylindrical shape container 12. The second opening is located at the second end of container 12 on axis Ax. The gas in container 12 may be sealed by container 12 and optical resonator 16. In this case, an apparatus for gas exchange is not required. Therefore, the size of gas laser 10 can be reduced. The degree of freedom of installation of gas laser 10 is increased.

The gas in container 12 may include at least one gas of carbon dioxide (CO2), nitrogen oxides (N₂O, NO₂, etc.), sulfur oxides (SO₂, etc.), ozone (O₃), ammonia (NH₃), methane (CH₄), and primary alcohol as a laser medium. The gas in container 12 may be a mixed gas including a first gas as a laser medium and a second gas different from the first gas. The second gas may include at least one of helium (He), hydrogen (H₂), and water vapor (H₂O). The second gas can cause transition from the energy level of the first gas to a lower ground level. The second gas may also cool the first gas. The gas in container 12 may not contain nitrogen. In one example, the gas in container 12 includes carbon dioxide (for example, 50 vol %) and helium (for example, 50 vol %). The pressure of the gas in container 12 is, for example, atmospheric pressure (1×10⁵ Pa).

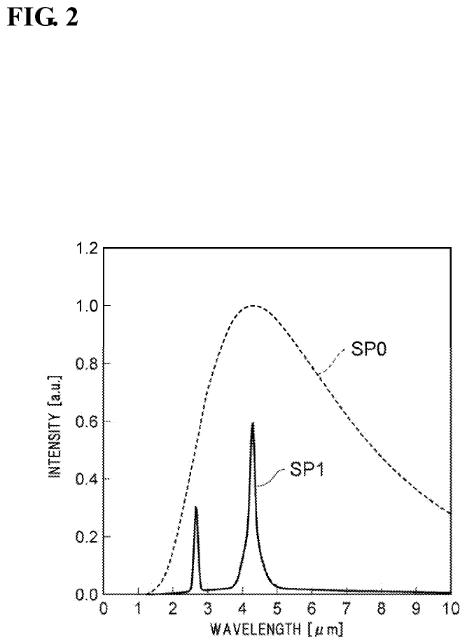

FIG. 2 is a graph illustrating an example of a thermal radiation spectrum of a thermal radiation source. The horizontal axis of FIG. 2 represents the wavelength. The vertical axis of FIG. 2 represents the intensity of the spectrum. A thermal radiation spectrum SP0 shown in FIG. 2 is an example of a thermal radiation spectrum emitted from a black body. A thermal radiation spectrum SP1 shown in FIG. 2 shows an example of the spectrum of excitation light TR emitted from thermal radiation source 14. Thermal radiation spectrum SP1 has a first peak in a wavelength range of 3 μm or more (for example, 4.3 μm). Thermal radiation spectrum SP1 may have a second peak in a wavelength range of 2 μm to 3 μm. The intensity of the second peak is less than the intensity of the first peak.

Thermal radiation source 14 may include at least one of a photonic crystal, a microcavity resonator, and a plasmonic meta-surface. The spectrum of excitation light TR emitted from thermal radiation source 14 has a peak at the excitation wavelength of gas as the laser medium.

Thermal radiation source 14 may be diamond having a sufficient thickness, zinc sulfide or zinc selenide doped with a transition metal such as iron or chromium. For example, diamond as thick as a 1 mm can operate as a source of wavelength-selective radiation at wavelengths from 4 μm to 6 μm. Thermal radiation source 14 may be a photonic crystal or the like containing these substances.

According to gas laser 10, thermal radiation source 14 emits excitation light TR by thermal radiation. As the emission light emitted from the gas by excitation light TR resonates, laser beam L is emitted. Accordingly, gas laser 10 includes thermal radiation source 14 as a new light source emitting excitation light TR. According to gas laser 10, since it is not necessary to excite gas by electric discharge, a high-voltage power source for electric discharge is not required. Therefore, the size and weight of gas laser 10 can be reduced. In addition, in a gas laser other than the carbon dioxide gas laser, when gas is excited by electric discharge or laser, the energy conversion efficiency decreases. For example, when gas is excited by a laser, the energy conversion efficiency for converting electrical energy into light energy is less than 10%. On the other hand, since gas is excited by thermal radiation in gas laser 10, high energy conversion efficiency can be obtained. For example, when gas is excited by thermal radiation, the energy conversion efficiency for converting electrical energy into light energy is 10% or more.

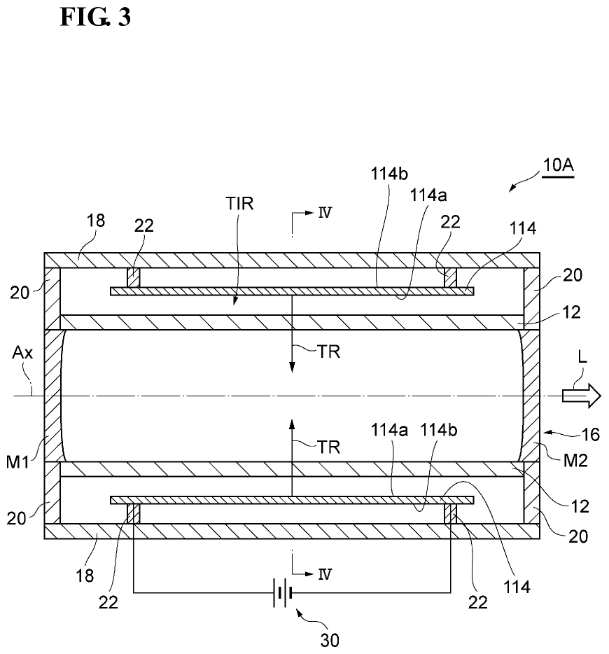

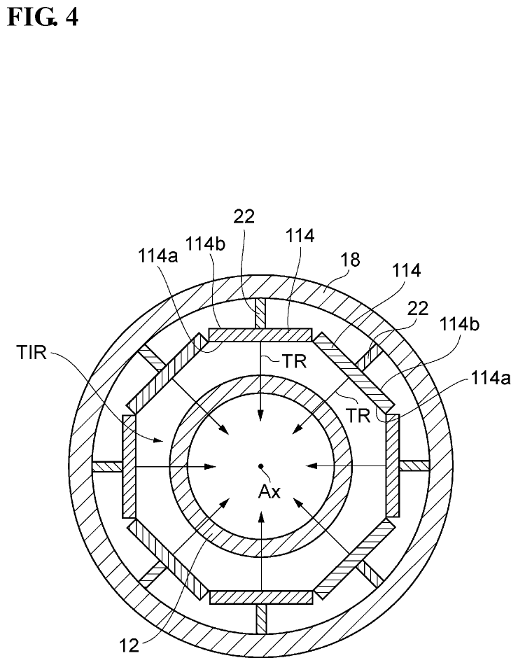

FIG. 3 is a cross-sectional view schematically illustrating a gas laser according to another embodiment. FIG. 4 is a cross-sectional view taken along line IV-IV of FIG. 3. A gas laser 10A shown in FIGS. 3 and 4 may have the same configuration as gas laser 10 except for the following points. Gas laser 10A may include thermal radiation source 114 and a power source 30 instead of thermal radiation source 14. Gas laser 10A may further include a container 18, a sealing member 20, and a protrusion 22.

Container 18 is disposed outside container 12. Container 18 is spaced apart from container 12. Container 18 may have a cylindrical shape extending along axis Ax. In one example, container 18 is a cylinder having an outside diameter of 50 mm, an inside diameter of 46 mm, and a length of 120 mm. Container 12 and container 18 may form a double tube.

Sealing member 20 seals the space between container 12 and container 18. At the first end of container 12 in axis Ax, one sealing member 20 is disposed between container 12 and container 18. In one example, sealing member 20 is an annular member. At the second end of container 12 in axis Ax, another sealing member 20 is disposed between container 12 and container 18. Container 12, container 18 and sealing member 20 may be formed by a single member. The space between container 12 and container 18 may be decompressed. An inert gas may be sealed in the space between container 12 and container 18. Examples of inert gases include nitrogen, argon, and krypton. The pressure of the inert gas may be 1 Pa or less.

Gas may flow through the space between container 12 and container 18 without using sealing member 20. Gas flows from the first end to the second end of container 12 along axis Ax. The gas may be a gas that hardly absorbs excitation light TR. This makes it easier for excitation light TR to reach the gas in container 12.

Thermal radiation source 114 may be disposed outside container 12. Thermal radiation source 114 may be disposed between container 12 and container 18. A thermally insulated region TIR may be disposed between container 12 and thermal radiation source 114. Thermally insulated region TIR may be a decompressed space between container 12 and container 18. Thermal radiation source 114 may be connected to container 18 by at least one protrusion 22. When the contact area between thermal radiation source 114 and protrusion 22 is small, heat dissipation from thermal radiation source 114 to protrusion 22 can be suppressed. Therefore, thermal radiation source 114 can be efficiently heated. By reducing the number of protrusions 22, the contact area between thermal radiation source 114 and protrusions 22 can be reduced. By reducing the cross-sectional area of protrusion 22 perpendicular to the protrusion direction of protrusion 22, the contact area between thermal radiation source 114 and protrusion 22 can be reduced.

Gas laser 10A may include a plurality of (for example, eight) thermal radiation sources 114. Each thermal radiation source 114 may extend along axis Ax. Each thermal radiation source 114 may be a plate member having a first surface 114a and a second surface 114b. First surface 114a is a surface from which excitation light TR is emitted. First surface 114a may face axis Ax and the outer surface of container 12. Second surface 114b is opposite to first surface 114a. Second surface 114b may face the inner surface of container 18. The plurality of thermal radiation sources 114 may be disposed to surround axis Ax and container 12 in a cross-section orthogonal to axis Ax. Adjacent thermal radiation sources 114 may be connected to form a single thermal radiation source 114. In this case, thermal radiation source 114 may have a cylindrical shape.

Gas laser 10A may include power source 30 connected to thermal radiation source 114. Power source 30 is disposed outside container 18. Power source 30 may be connected to the plurality of thermal radiation sources 114 in parallel. Power source 30 may be a DC power source. The conducting wire between thermal radiation source 114 and power source 30 may extend along protrusion 22.

When power is supplied from power source 30 to each thermal radiation source 114, excitation light TR is emitted from each heated thermal radiation source 114 to the gas in container 12. The gas is excited by excitation light TR and laser beam L is emitted from gas laser 10A. In one example, when a voltage of 5 V is supplied from power source 30 to thermal radiation source 114, laser beam L having an output of 0.6 W is emitted. Among excitation light TR emitted from one thermal radiation source 114, excitation light TR that is not absorbed by the gas may be incident on another thermal radiation source 114. In this case, a decrease in the temperature of thermal radiation source 114 on which excitation light TR is incident is suppressed.

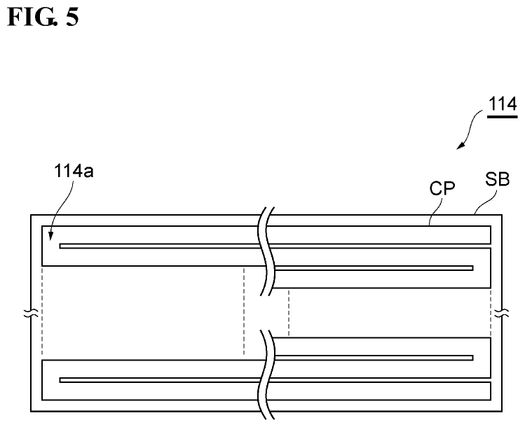

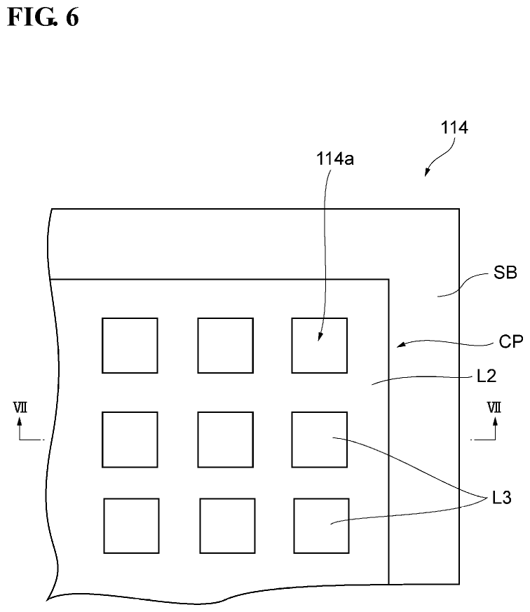

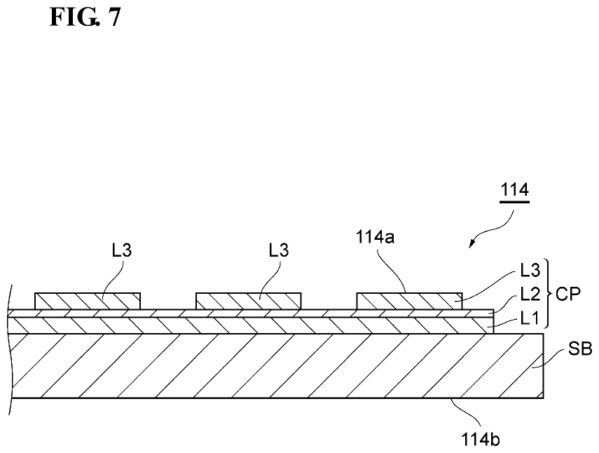

FIG. 5 is a plan view illustrating an example of a thermal radiation source. FIG. 6 is a plan view of a portion of FIG. 5. FIG. 7 is a cross-sectional view taken along line VII-VII of FIG. 6. As shown in FIGS. 5 to 7, thermal radiation source 114 may include a substrate SB and a conductor pattern region CP disposed on substrate SB. Substrate SB is, for example, a glass substrate or a polymer substrate. In one example, substrate SB has a main surface having a long side of 100 mm and a short side of 15 mm, and a thickness of 2 mm.

Conductor pattern region CP is disposed on first surface 114a of thermal radiation source 114. Conductor pattern region CP may be a meandering strip-shaped region on first surface 114a. In one example, in conductor pattern region CP, strip-shaped regions having widths of 2.3 mm meander at intervals of 0.2 mm.

Conductor pattern region CP includes a first layer L1, a second layer L2, and a third layer L3. First layer L1, second layer L2, and third layer L3 are sequentially disposed on substrate SB. First layer L1 and second layer L2 may extend over the entire conductor pattern region CP. First layer L1 may be a metal layer. First layer L1 is, for example, an aluminum layer. In one example, first layer L1 is 100 nm thick. Second layer L2 may be a dielectric film layer. Second layer L2 is, for example, an aluminum oxide layer. In one example, second layer L2 is 50 nm thick. Third layer L3 may be a metal layer. Third layer L3 is, for example, an aluminum layer. Third layer L3 may be a plurality of island patterns spaced apart from each other and disposed in an array. In one example, the plurality of island patterns are provided at a pitch of 1500 nm. In one example, each island pattern has a square main surface with sides of 980 nm and a thickness of 100 nm.

Power source 30 in FIG. 3 may be connected to first layer L1 which is a resistance heating element of thermal radiation source 114. The positive electrode of power source 30 may be connected to the first end of conductor pattern region CP. The negative electrode of power source 30 may be connected to the second end of conductor pattern region CP. As the current flows through first layer L1, conductor pattern region CP is heated.

According to gas laser 10A, the same effect as that of gas laser 10 can be obtained. Further, the following effects can be obtained.

When thermally insulated region TIR is disposed between container 12 and thermal radiation source 114, an increase in the temperature of the gas in container 12 can be suppressed even if the temperature of thermal radiation source 114 is high. Therefore, it is possible to suppress a decrease in oscillation efficiency of laser beam L.

When thermal radiation source 114 extends along axis Ax, thermal radiation source 114 may irradiate excitation light TR toward the gas in a long region along axis Ax. When thermal radiation source 114 is disposed to surround axis Ax in the cross section orthogonal to axis Ax, thermal radiation source 114 can irradiate excitation light TR to the gas from many directions.

When the inner surface of container 12 includes the reflecting surface that reflects excitation light TR, excitation light TR that is not absorbed by the gas and reaches the reflecting surface can be reflected toward the gas.

When the reflecting surface of the inner surface of container 12 is disposed so as to face thermal radiation source 114, even if excitation light TR reflected by the reflecting surface is not absorbed by the gas, reflected excitation light TR returns to thermal radiation source 114. Therefore, the energy for heating thermal radiation source 114 can be reduced.

When thermal radiation source 114 includes first layer L1 and power source 30 is connected to first layer L1, thermal radiation source 114 can be heated by energization.

When thermal radiation source 114 is disposed outside container 12 and container 12 includes a material that transmits excitation light TR, the degree of freedom of arrangement of thermal radiation source 114 can be improved.

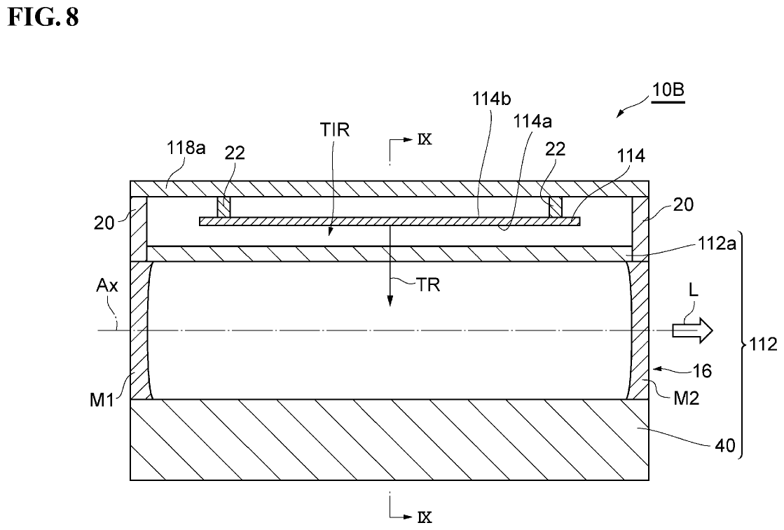

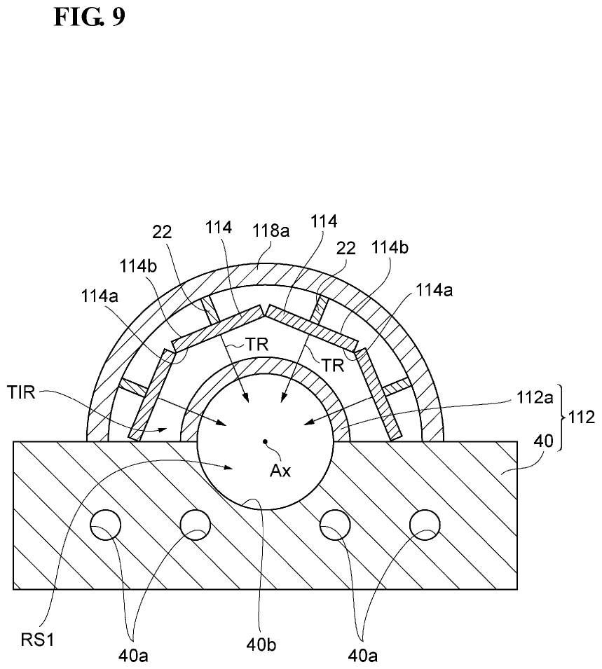

FIG. 8 is a cross-sectional view schematically illustrating a gas laser according to another embodiment. FIG. 9 is a cross-sectional view taken along line IX-IX of FIG. 8. A gas laser 10B shown in FIGS. 8 and 9 may have the same configuration as gas laser 10A except for the following points. Gas laser 10B may include a container 112 instead of container 12. Gas laser 10B may include a dielectric member 118a instead of container 18.

Container 112 includes a dielectric member 112a and a metal member 40. Dielectric member 112a and metal member 40 extend along axis Ax. In one example, dielectric member 112a is a half-cylindrical shape having an outside diameter of 26 mm, an inside diameter of 24 mm, and a length of 120 mm. Examples of materials of dielectric member 112a are the same as the examples of materials of container 12 in FIG. 1.

Metal member 40 is, for example, an aluminum member. Metal member 40 may be a plate member extending along axis Ax. Metal member 40 has a recess RS1 extending along axis Ax. An inner surface 40b of recess RS1 forms part of the inner surface of container 112. In one example, inner surface 40b is a half-cylindrical inner surface having an inside diameter of 26 mm. Inner surface 40b may be a reflecting surface that reflects excitation light TR. A reflectance of inner surface 40b with respect to excitation light TR may be 90% or more. Inner surface 40b may be disposed to face thermal radiation source 114.

Gas laser 10A may include dielectric member 118a disposed outside dielectric member 112a. Dielectric member 118a is spaced apart from dielectric member 112a. Dielectric member 118a may extend along axis Ax. In one example, dielectric member 118a is a half-cylindrical shape having an outside diameter of 50 mm, an inside diameter of 46 mm, and a length of 120 mm. Examples of materials for dielectric member 118a are the same as examples of materials for container 18 in FIG. 3.

Metal member 40 may be connected to dielectric member 112a and dielectric member 118a. Metal member 40 and sealing member 20 may seal a space between dielectric member 112a and dielectric member 118a. Thermal radiation source 114 may be disposed in a space between dielectric member 112a and dielectric member 118a. Thermal radiation source 114 may be connected to dielectric member 118a by at least one protrusion 22.

Metal member 40 may include a flow channel 40a for flowing a cooling fluid. The cooling fluid may include water. In one example, the temperature of the cooling fluid is room temperature (25° C.).

According to gas laser 10B, the same effect as that of gas laser 10A can be obtained. Further, according to gas laser 10B, the gas in container 112 can be cooled by metal member 40. When metal member 40 includes flow channel 40a, the cooling effect of the gas may be enhanced.

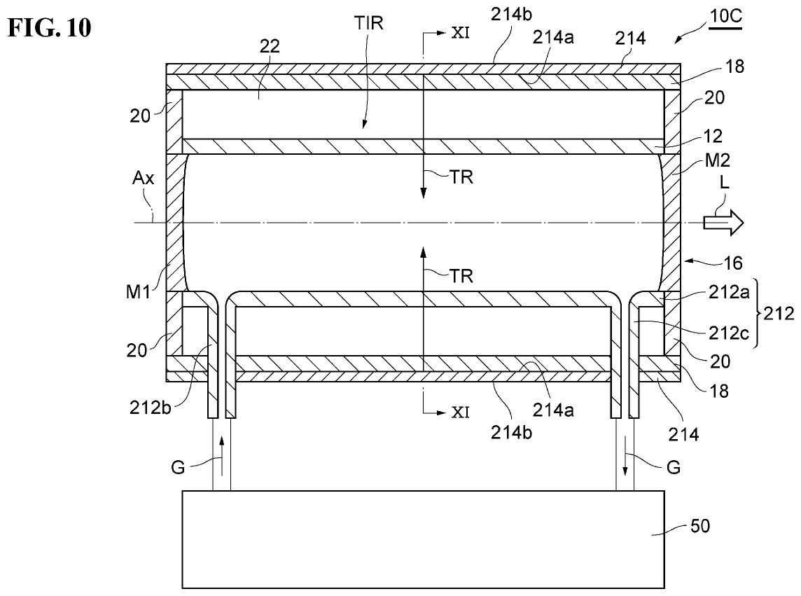

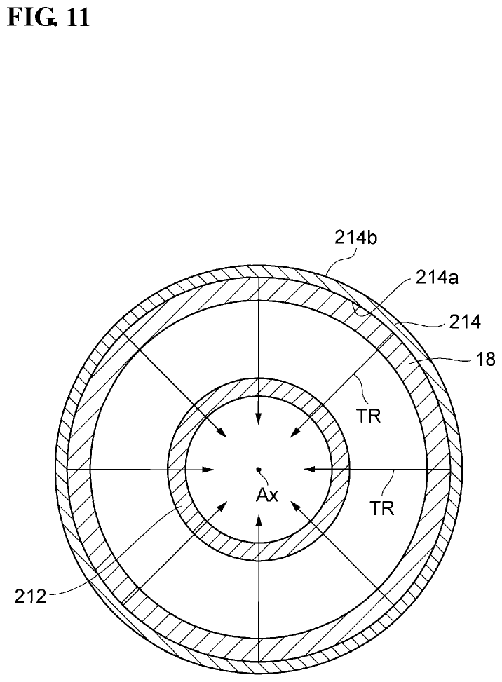

FIG. 10 is a cross-sectional view schematically illustrating a gas laser according to another embodiment. FIG. 11 is a cross-sectional view taken along line XI-XI of FIG. 10. A gas laser 10C shown in FIGS. 10 and 11 may have the same configuration as that of gas laser 10A except for the following points. Gas laser 10C may include a container 212 instead of container 12. Gas laser 10C may include a thermal radiation source 214 instead of thermal radiation source 114. Gas laser 10C may further include a cooler 50. Gas laser 10C may not include power source 30.

Container 212 includes a main body 212a, a gas supply duct 212b connected to main body 212a, and a gas exhaust duct 212c connected to main body 212a. Main body 212a may have the same configuration as container 12 except for the following points. Main body 212a may have a first opening connected to gas supply duct 212b and a second opening connected to gas exhaust duct 212c.

Cooler 50 is connected to gas supply duct 212b and gas exhaust duct 212c. Cooler 50 performs heat exchange with a gas G in container 212. Thus, gas G is cooled. Gas G circulates between container 212 and cooler 50 through gas supply duct 212b and gas exhaust duct 212c.

Thermal radiation source 214 may be disposed outside container 18. Thermal radiation source 214 may extend along axis Ax. Thermal radiation source 214 may be disposed to surround container 18. Thermal radiation source 214 may be a cylindrical member extending along axis Ax. Thermal radiation source 214 may have a first surface 214a and a second surface 214b. First surface 214a is a surface from which excitation light TR is emitted. First surface 214a faces the outer surface of container 18. First surface 214a may be in contact with an outer surface of container 18. Second surface 214b is opposite to first surface 214a. Second surface 214b is a surface that recovers heat from the heating element located outside gas laser 10C. Second surface 214b may be in contact with the heating element. In this case, thermal radiation source 214 is heated by heat transfer. Second surface 214b may be spaced apart from the heating element. In this case, thermal radiation source 214 is heated by the thermal radiation from the heating element. The temperature of the heating element may be 300° C. or more. Thermal radiation source 214 may be disposed inside container 18. Gas laser 10C may not include container 18. In this case, thermal radiation source 214 also functions as container 18.

According to gas laser 10C, the same effect as that of gas laser 10A can be obtained. Further, according to gas laser 10C, the gas in container 212 can be cooled by cooler 50. According to gas laser 10C, laser beam L can be emitted by using waste heat of the heating element by thermal radiation source 214. There is no need to supply power from power source 30 to thermal radiation source 214.

In other gas lasers 10, 10A, 10B, thermal radiation source 214 may be used. This eliminates the need for power source 30.

In other gas lasers 10, 10A, 10B, container 212 and cooler 50 may be used. This allows the gas in container 212 to be cooled.

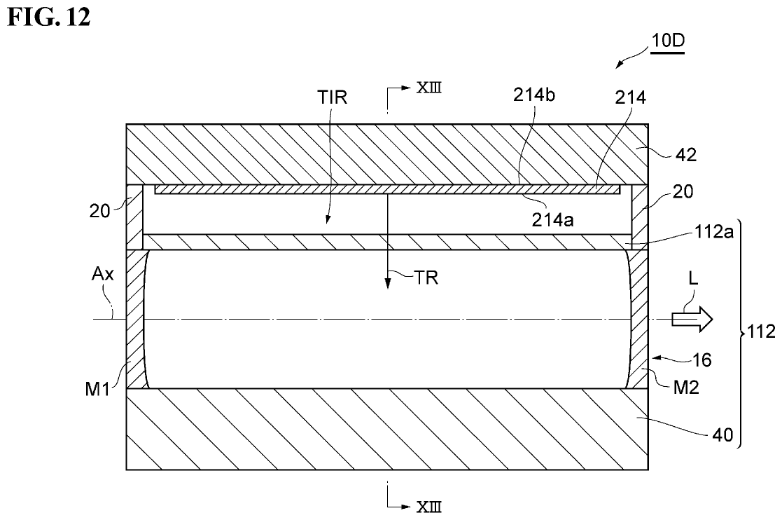

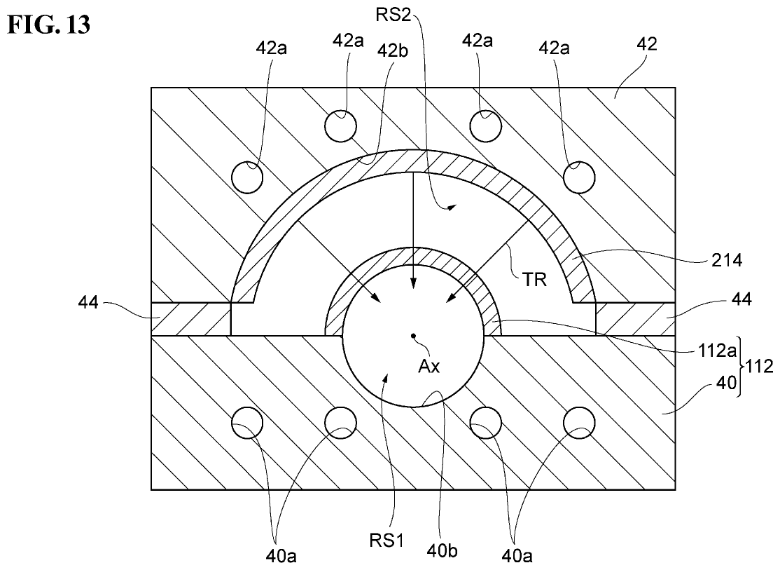

FIG. 12 is a cross-sectional view schematically illustrating a gas laser according to another embodiment. FIG. 13 is a cross-sectional view taken along line XIII-XIII of FIG. 12. A gas laser 10D shown in FIGS. 12 and 13 may have the same configuration as that of gas laser 10B except for the following points. Gas laser 10D may include thermal radiation source 214 instead of thermal radiation source 114. Gas laser 10D may include a metal member 42 instead of dielectric member 118a. Gas laser 10D may include a heat insulator 44. Gas laser 10D may not include power source 30.

Metal member 42 may be disposed outside container 112. Metal member 42 is, for example, an aluminum member. Metal member 42 may be a plate member extending along axis Ax. Metal member 42 has a recess RS2 extending along axis Ax. An inner surface 42b of recess RS2 faces dielectric member 112a. Inner surface 42b is spaced apart from dielectric member 112a. In one example, inner surface 42b is a half-cylindrical inner surface having an inside diameter of 100 mm. Thermal radiation source 214 is disposed between inner surface 42b and dielectric member 112a.

Metal member 42 may include a flow channel 42a for flowing a high temperature fluid. The high temperature fluid may include a high-temperature gas such as water vapor. In one example, the temperature of the hot fluid is 300° C. Metal member 42 may be heated by the heating element. In this case, metal member 42 may not include flow channel 42a. The heating element may be in contact with metal member 42 or may be spaced apart from metal member 42.

Heat insulator 44 may be disposed between metal member 40 and metal member 42. Metal member 40 and metal member 42 may be connected to each other by heat insulator 44. Heat insulator 44 may extend along axis Ax. Heat insulator 44 includes, for example, porous calcium silicate.

Container 112, metal member 42, and heat insulator 44 may seal a space between dielectric member 112a and inner surface 42b.

According to gas laser 10D, the same effect as that of gas laser 10B can be obtained. Further, according to gas laser 10D, thermal radiation source 214 can be heated by metal member 42.

Metal member 42 and thermal radiation source 214 may be used in other gas lasers 10, 10A, 10B, and 10C. This eliminates the need for power source 30.

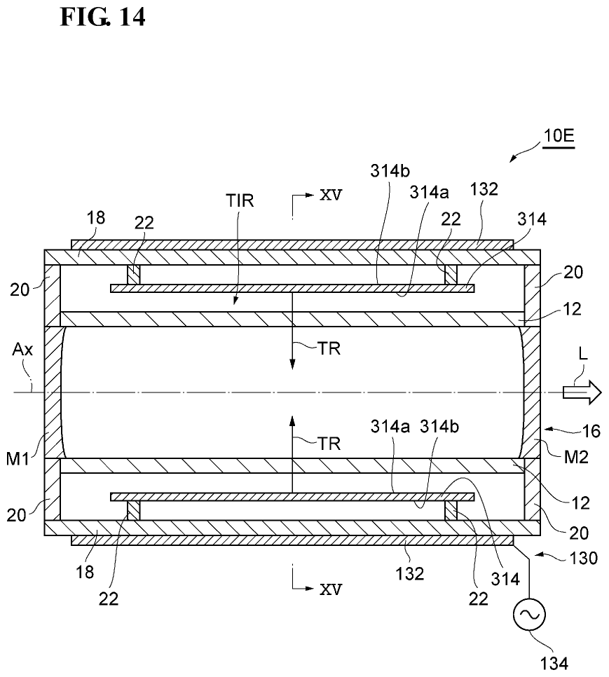

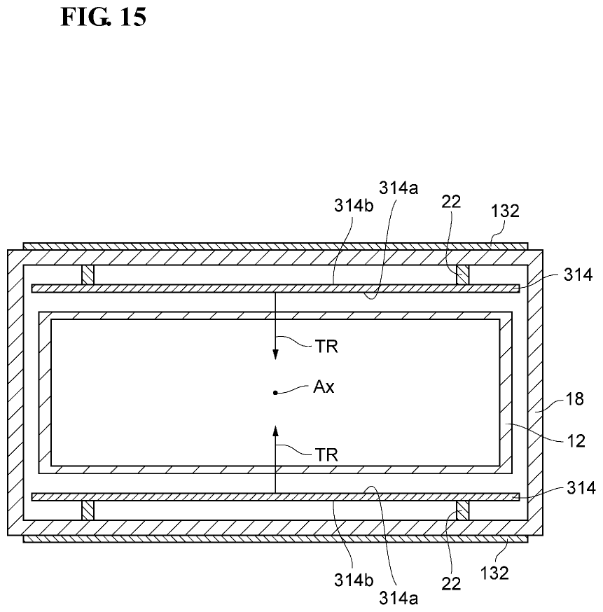

FIG. 14 is a cross-sectional view schematically illustrating a gas laser according to another embodiment. FIG. 15 is a cross-sectional view taken along line XV-XV of FIG. 14. A gas laser 10E shown in FIGS. 14 and 15 may have the same configuration as that of gas laser 10A except for the following points. Gas laser 10E may include a thermal radiation source 314 instead of thermal radiation source 114. Gas laser 10E may include a heater 130 instead of power source 30. Gas laser 10E may include container 12 having a rectangular parallelepiped outer shape. Gas laser 10E may include container 18 having a rectangular parallelepiped outer shape.

In a cross section orthogonal to axis Ax, container 12 has a rectangular outer shape. In a cross-section orthogonal to axis Ax, thermal radiation source 314 may extend along a long side of the rectangle of container 12. Thermal radiation source 314 may extend along the short side of the rectangle of container 12 or may not be disposed at the short side of the rectangle. Even if thermal radiation source 314 is disposed only on the long side of the rectangle of container 12, the gas in container 12 can be excited with high efficiency.

Thermal radiation source 314 may be disposed between container 12 and container 18. Thermal radiation source 314 may be a plate member having a first surface 314a and a second surface 314b. First surface 314a is a surface from which excitation light TR is emitted. First surface 314a faces axis Ax and the outer surface of container 12. Second surface 314b is opposite to first surface 314a. Second surface 314b faces the inner surface of container 18.

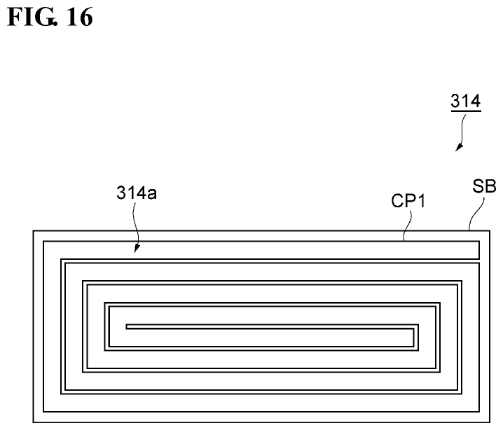

FIG. 16 is a plan view illustrating an example of a thermal radiation source. Thermal radiation source 314 shown in FIG. 16 may include substrate SB and a conductor pattern region CP1 disposed on substrate SB. Conductor pattern region CP1 is disposed on first surface 314a of thermal radiation source 314. Conductor pattern region CP1 has the same configuration as that of conductor pattern region CP except that it is disposed in a spiral shape on first surface 314a.

As shown in FIGS. 14 and 15, heater 130 includes a coil 132 for inductively heating the conductors (for example, first layer L1 and third layer L3 of conductor pattern region CP1) of thermal radiation source 314, and an AC power source 134 for supplying AC power to coil 132. Coil 132 may be a spiral coil. The spiral coil has a pattern corresponding to conductor pattern region CP1. Coil 132 faces conductor pattern region CP1 of thermal radiation source 314. In one example, the frequency of AC power source 134 is 50 Hz.

According to gas laser 10E, the same effect as that of gas laser 10A can be obtained. Further, according to gas laser 10E, thermal radiation source 314 can be heated by heater 130 in a non-contact manner. Therefore, heat emitted from thermal radiation source 314 to the outside through the conductor can be suppressed. Therefore, thermal radiation source 314 can be efficiently heated. When coil 132 is a spiral coil having a pattern corresponding to conductor pattern region CP1, energy conversion efficiency from electrical energy to thermal energy can be increased.

Thermal radiation source 314 and heater 130 may be used in other gas lasers 10, 10A, 10B, 10C, and 10D. Thus, thermal radiation source 314 can be heated in a non-contact manner.

In other gas lasers 10, 10A, 10B, 10C, and 10D, container 12 having the outer shape of a rectangular parallelepiped and container 18 having the outer shape of a rectangular parallelepiped may be used.

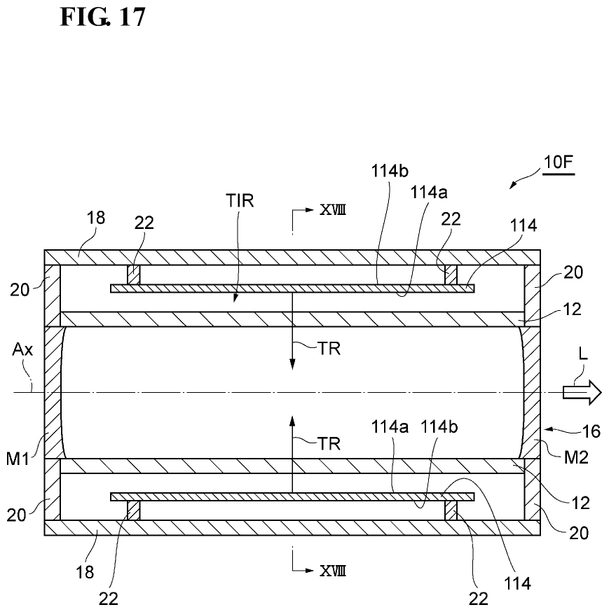

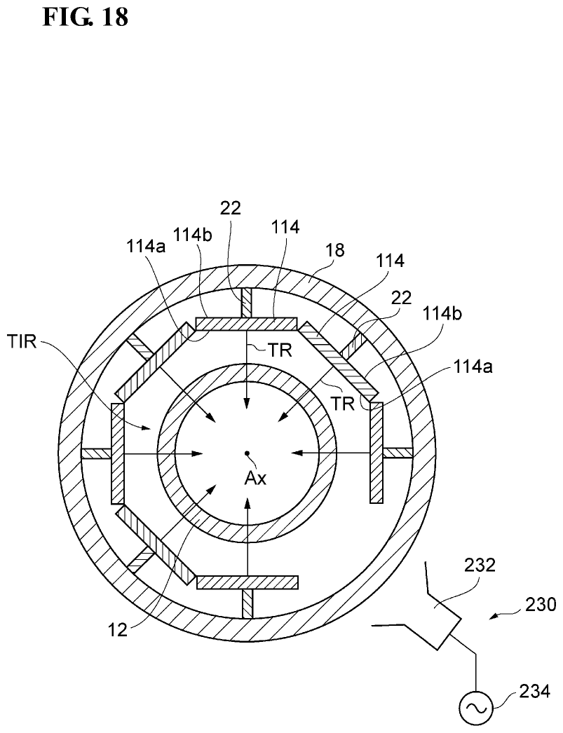

FIG. 17 is a cross-sectional view schematically illustrating a gas laser according to another embodiment. FIG. 18 is a cross-sectional view taken along line XVIII-XVIII of FIG. 17. A gas laser 10F shown in FIGS. 17 and 18 may have the same configuration as gas laser 10A except for the following points. Gas laser 10F may include an electromagnetic wave radiator 230 instead of power source 30.

Electromagnetic wave radiator 230 radiates electromagnetic waves to thermal radiation source 114 to heat thermal radiation source 114. Electromagnetic wave radiator 230 includes an antenna 232 for emitting electromagnetic waves and a high-frequency power source 234 connected to antenna 232. In one example, the frequency of high-frequency power source 234 is 2.4 GHz. The frequencies of electromagnetic waves emitted from electromagnetic wave radiator 230 may range from 100 Hz to 10 GHz. For example, microwaves may be irradiated to thermal radiation source 114 to heat thermal radiation source 114 by dielectric heating. Thermal radiation source 114 may include a dielectric. Each of container 12 and container 18 may include a material that transmits electromagnetic waves.

According to gas laser 10F, the same effect as that of gas laser 10A can be obtained. Further, according to gas laser 10F, thermal radiation source 114 can be heated in a non-contact manner by electromagnetic wave radiator 230. Therefore, heat emitted from thermal radiation source 114 to the outside through the conductor can be suppressed. Therefore, thermal radiation source 114 can be efficiently heated.

Electromagnetic wave radiator 230 may be used in other gas lasers 10, 10A, 10B, 10C, 10D, and 10E. Thus, thermal radiation sources 14, 114, 214 can be heated in a non-contact manner.

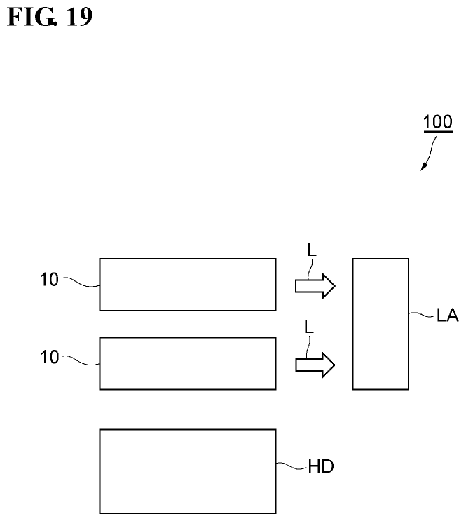

FIG. 19 schematically illustrates a waste heat recovery system according to one embodiment. A waste heat recovery system 100 shown in FIG. 19 includes gas laser 10 and a heating element HD for heating thermal radiation source 14 of gas laser 10. Waste heat recovery system 100 may include a plurality of gas lasers 10. Heating element HD may be in contact with thermal radiation source 14 or may be spaced apart from thermal radiation source 14. Heating element HD may be a hot solid or a hot fluid. Waste heat recovery system 100 may include a light absorber LA that absorbs laser beam L emitted from each gas laser 10. Light absorber LA may be at least one of a photoelectric cell and a chemical reactor.

According to waste heat recovery system 100, thermal radiation source 14 of gas laser 10 is heated by heating element HD and then excitation light TR is emitted from thermal radiation source 14. As a result, laser beam L is emitted from each gas laser 10. Laser beam L is irradiated toward light absorber LA and absorbed by light absorber LA. Therefore, the waste heat of heating element HD can be recovered and utilized in light absorber LA. Since laser beam L has a high light-condensing property, laser beams L from the plurality of gas lasers 10 can be condensed in a narrow range. Therefore, the temperature of light absorber LA can be higher than the temperature of heating element HD. Heating element HD may have a large surface area for heat dissipation. In this case, the number of gas lasers 10 that can be installed can be increased. Thus, the temperature of light absorber LA can be increased.

Waste heat recovery system 100 may include gas lasers 10, 10A, 10B, 10C, 10D, 10E, and 10F instead of gas laser 10.

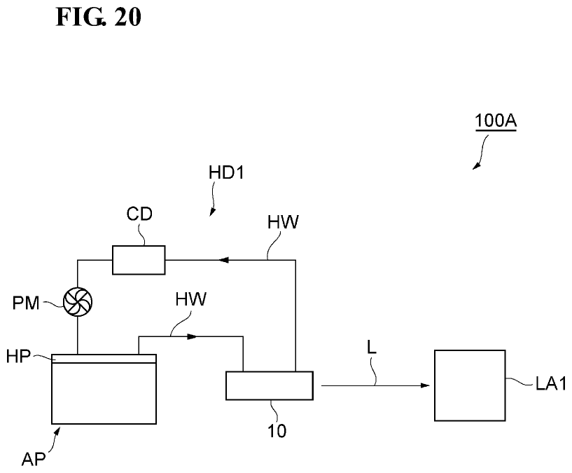

FIG. 20 schematically illustrates a waste heat recovery system according to another embodiment. A waste heat recovery system 100A shown in FIG. 20 includes gas laser 10, a water vapor HW which is a heating element for heating thermal radiation source 14 of gas laser 10, and a photoelectric cell LA1 for converting laser beam L from gas laser 10 into electricity. Waste heat recovery system 100A may include a plurality of gas lasers 10. Water vapor HW is generated by heating water by a heat emission unit HP of an apparatus AP. Water vapor HW flows from heat emission unit HP toward gas laser 10. Water vapor HW is cooled by heating thermal radiation source 14. Cooled water vapor HW is supplied to a condenser CD and condensed in condenser CD. The condensed water is returned to apparatus AP by a pump PM.

According to waste heat recovery system 100A, thermal radiation source 14 is heated by water vapor HW and then excitation light TR is emitted from thermal radiation source 14. As a result, laser beam L is emitted from gas laser 10. Laser beam L is irradiated toward photoelectric cell LA1 and is converted into electricity in photoelectric cell LA1. According to waste heat recovery system 100A, waste heat can be recovered and used as electricity. Since laser beam L has a high light-condensing property, laser beams L from the plurality of gas lasers 10 can be condensed in a narrow range. Therefore, the power generated by photoelectric cell LA1 can be increased. The power generation efficiency of photoelectric cell LA1 can also be increased.

Waste heat recovery system 100A may include gas lasers 10, 10A, 10B, 10C, 10D, 10E, and 10F instead of gas laser 10.

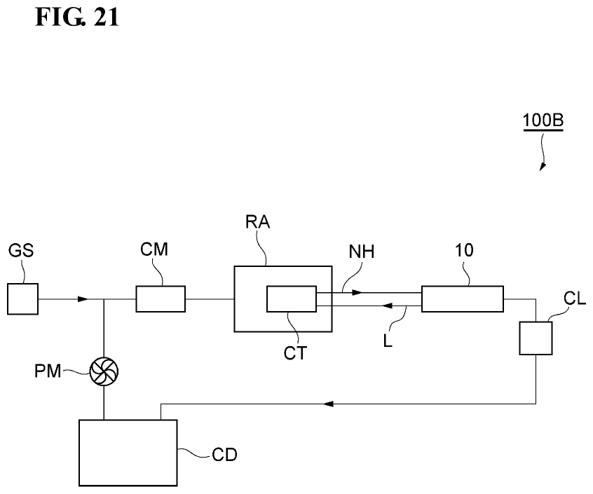

FIG. 21 schematically illustrates a waste heat recovery system according to another embodiment. A waste heat recovery system 100B shown in FIG. 21 may be a system for synthesizing ammonia by the Haber-Bosch process. Waste heat recovery system 100B includes gas laser 10, an ammonia gas NH which is a heating element for heating thermal radiation source 14 of gas laser 10, and a chemical reactor RA irradiated with laser beam L from gas laser 10. Chemical reactor RA may include a catalyst CT. In one example, the temperature of catalyst CT is 500° C. Catalyst CT includes iron, aluminum oxide and potassium oxide.

Waste heat recovery system 100B includes a gas supply source GS for supplying nitrogen and hydrogen to chemical reactor RA. A compressor CM is disposed between gas supply source GS and chemical reactor RA. Nitrogen and hydrogen supplied from gas supply source GS are compressed in compressor CM and then supplied to chemical reactor RA. In chemical reactor RA, nitrogen and hydrogen react with each other by catalyst CT to synthesize ammonia gas NH. In one example, the temperature of ammonia gas NH in chemical reactor RA is 480° C. Ammonia gas NH is supplied to gas laser 10 to heat thermal radiation source 14 of gas laser 10. Ammonia gas NH is cooled by heating thermal radiation source 14. Cooled ammonia gas NH is supplied to a cooler CL and is cooled in cooler CL. Cooled ammonia gas NH is supplied to condenser CD and condensed in condenser CD. The condensed ammonia is returned to compressor CM by pump PM.

According to waste heat recovery system 100B, thermal radiation source 14 is heated by ammonia gas NH and then excitation light TR is emitted from thermal radiation source 14. As a result, laser beam L is emitted from gas laser 10. Laser beam L is irradiated toward chemical reactor RA to heat catalyst CT in chemical reactor RA. Therefore, energy required for heating catalyst CT can be reduced. As described above, according to waste heat recovery system 100B, waste heat can be recovered and used as heat for a chemical reaction.

Waste heat recovery system 100B may include gas lasers 10, 10A, 10B, 10C, 10D, 10E, and 10F instead of gas laser 10.

Although preferred embodiments of the present disclosure have been described in detail above, the present disclosure is not limited to the above embodiments.

It should be understood that the embodiments disclosed herein are illustrative in all respects and are not restrictive. The scope of the present invention is defined by the appended claims rather than by the foregoing description, and is intended to include all modifications within the scope and meaning equivalent to the appended claims.

What is claimed is:

1. A gas laser comprising:
a gas serving as a laser medium;
a thermal radiation source having wavelength selectivity and configured to emit excitation light for excitation of the gas by thermal radiation; and
an optical resonator for causing emission light emitted from the gas in response to the excitation light to resonate.

2. The gas laser according to claim 1, wherein a thermally insulated region is disposed between the gas and the thermal radiation source.

3. The gas laser according to claim 1, further comprising a container containing the gas,
wherein the container has a cylindrical shape extending along an axis, and
the thermal radiation source extends along the axis.

4. The gas laser according to claim 1, further comprising a container containing the gas,
wherein the container has an inner surface including a reflecting surface configured to reflect the excitation light.

5. The gas laser according to claim 4, wherein the reflecting surface is disposed so as to face the thermal radiation source.

6. The gas laser according to claim 1, wherein the thermal radiation source includes a resistance heating element, and
the gas laser further comprises a power source connected to the resistance heating element.

7. The gas laser according to claim 1, wherein the thermal radiation source includes a conductor, and
the gas laser further comprises:
a coil for inductively heating the conductor; and
an AC power source for supplying AC power to the coil.

8. The gas laser according to claim 1, further comprising an electromagnetic wave generator for irradiating the thermal radiation source with electromagnetic waves to heat the thermal radiation source.

9. The gas laser according to claim 1, further comprising a container containing the gas,
wherein the container includes a metal member.

10. The gas laser according to claim 1, further comprising a cooler for cooling the gas.

11. The gas laser according to claim 1, further comprising a container containing the gas,
wherein the thermal radiation source is disposed outside the container, and
the container includes a material transmitting the excitation light.

12. A waste heat recovery system comprising:
a gas laser, the gas laser including,
a gas serving as a laser medium,
a thermal radiation source having wavelength selectivity and configured to emit excitation light for excitation of the gas by thermal radiation, and
an optical resonator for causing emission light emitted from the gas in response to the excitation light to resonate; and
a heating element for heating the thermal radiation source of the gas laser.

13. The waste heat recovery system according to claim 12, further comprising a photoelectric cell configured to convert a laser beam from the gas laser into electricity.

14. The waste heat recovery system according to claim 12, further comprising a chemical reactor configured to be irradiated with a laser beam from the gas laser.
